(19) United States
(12) Patent Application Publication
(10) Pub. No.: US 2015/0006332 A1
(43) Pub. Date: Jan. 1, 2015

(54) SYSTEMS AND METHODS PROVIDING BUSINESS DATA VIA THREE DIMENSIONAL VIRTUAL ENVIRONMENT

(71) Applicants: Barak Kinarti, Kfar Saba (IL); Nathan Ari, Zoran (IL); Tomer Gabbai, Kfar Saba (IL)

(72) Inventors: Barak Kinarti, Kfar Saba (IL); Nathan Ari, Zoran (IL); Tomer Gabbai, Kfar Saba (IL)

(21) Appl. No.: 13/930,741

(22) Filed: Jun. 28, 2013

(51) Int. Cl. G06Q 10/10; G06Q 30/06

(52) U.S. Cl. CPC G06Q 10/10; G06Q 30/0643
USPC 705/27.1; 705/342; 705/39

(57) ABSTRACT

According to some embodiments, business data may be received from a remote business server. A graphical three-dimensional virtual environment may then be dynamically rendered, in substantially real time, based on the received business data. Interactions may occur with a user via the virtual environment, and business data stored at the remote business server may be updated in accordance with the interactions.

### FIELD

Some embodiments relate to systems and methods associated with business data. More specifically, some embodiments are directed to systems and methods to provide business data via a three dimensional virtual environment.

### BACKGROUND

A user may access business data for a number of different reasons. A customer, for example, might want to view inventory information and product options when making a purchase. An employee of an enterprise might want to view sales and profit figures and/or update information about pending purchase orders via an enterprise resource planning system and/or web-based portal platform. Typically, users access business data via spreadsheets, reports, web portals, etc. Such approaches, however, may require the user to have some experience in how to request and sift through the information. Moreover, these types of presentation of business information may not be fully engaging for the user.

Accordingly, methods and mechanisms to efficiently, accurately, and automatically access business data in a relatively engaging manner may be provided in accordance with some embodiments described herein.

### BRIEF DESCRIPTION OF THE DRAWINGS

FIG. 1 is a block diagram of a system according to some embodiments.

FIG. 2 is a flow diagram of a process in accordance with some embodiments.

FIG. 3 illustrates a display of a three-dimensional virtual environment in accordance with some embodiments.

FIG. 4 illustrates a display of supplemental business information in accordance with some embodiments.

FIG. 5 illustrates a display of a selectable item in accordance with some embodiments.

FIG. 6 illustrates a display of a three-dimensional representation of a product in accordance with some embodiments.

FIG. 7 is a block diagram of an apparatus according to some embodiments.

FIG. 8 illustrates a portion of a tabular database that might be stored in accordance with some embodiments.

FIG. 9 illustrates a display of a three-dimensional virtual environment in accordance with another embodiment.

FIG. 10 illustrates a display of a three-dimensional virtual environment on a tablet and/or wireless device in accordance with some embodiments.

### DETAILED DESCRIPTION

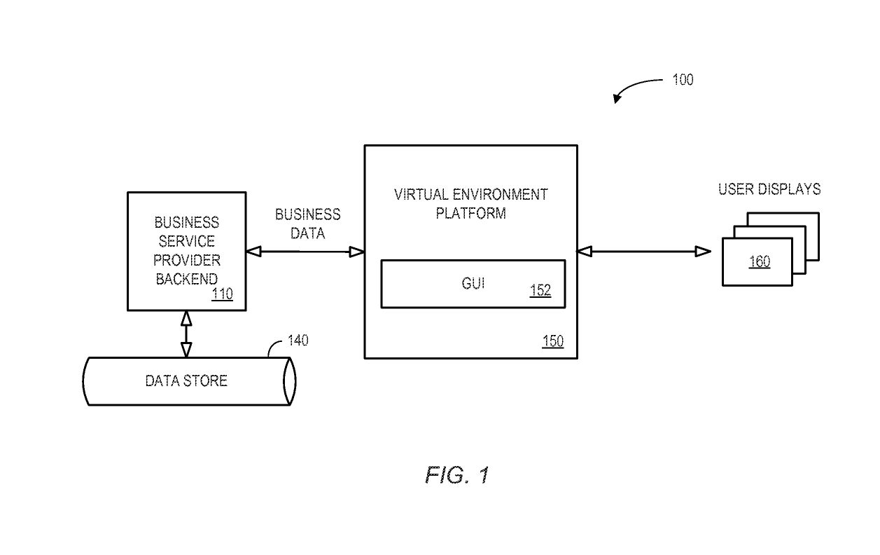

Users, such as potential customers and employees, may access business data via an enterprise resource planning system and/or web-based portal platform. Typically, users access business data via spreadsheets, reports, web portals, etc. Such approaches, however, may require the user to have some experience in how to request and sift through the information and may not be fully engaging for the user. Accordingly, methods and mechanisms to efficiently, accurately, and automatically display and/or alter business data in a relatively engaging manner may be provided in accordance with some embodiments described herein. For example, FIG. 1 is a block diagram 100 of a system according to some embodiments. The system 100 includes a business service provider backend 110 coupled to one or more databases or data stores containing business data 140. By way of example only, the business service provider backend 110 might be associated with an Enterprise Resource Planning (ERP) server, a business services gateway, a HyperText Transfer Protocol (HTTP) server, an Advanced Business Application Programming (ABAP) server, a cloud-based business application, and/or a TCP/IP server.

The business service provider backend 110 may provide business data services to users of the system 100. For example, the business service provider backend 110 might store customer information into and retrieve customer information from physical tables of data store 140. The data stored in data store 140 may be received from disparate hardware and software systems, some of which might not be operational with one another. The systems may comprise a back-end data environment employed in a business or industrial context. The data may be pushed to data store 140 and/or provided in response to queries received therefrom.

The data of data store 140 may reside in a physical database or stored in-memory (e.g., in Random Access Memory). The data may comprise a relational database, an in-memory database, a multi-dimensional database, an eXtendable Markup Language (XML) document, and/or any other structured data storage system. The physical tables of data store 140 may be distributed among several relational databases, dimensional databases, and/or other data sources. To provide economies of scale, data store 140 may include data of more than one enterprise. In such cases, the business service provider backend 110 may include mechanisms to ensure that a particular enterprise accesses only the data that the enterprise is authorized to access. Moreover, the data in the data store 140 may be indexed and/or selectively replicated in an index to allow fast retrieval thereof.

The structures of and relationships between the physical database tables may be complex, and business object models (referred to henceforth as “business objects”) may be used to shield developers and end-users from these complexities. The system 100 may implement metadata models to support different business solutions. The metadata models may include generic models of a business object, a floor plan (i.e., a user interface layout), user interface text, a process component, and a message type, among others. A business object, for example, may be a software model representing real-world items used during the transaction of business. An instance of a business object metadata model may comprise a SalesOrder object model or an Organization object model. Instances of these object models, in turn, may represent specific data (e.g., SalesOrder 4711, ACME corporation) and may provide a mapping to the underlying tables storing the specific data associated with a particular sales order.

A user may access information in the data store 140 via one or more user displays 160. For example, a user might view information about product inventory stored in the data store 140 via a user display 160. According to some embodiments, the user displays 160 are generated by a virtual environment platform 150 in communication with the business service provider backend 110. Moreover, the virtual environment platform 150 may include a Graphical User Interface (“GUI”) 152 to render the user displays 160 based on the business data in the data store 140.

According to some embodiments the user displays 160 are provided to a user via one or more user devices executing program code of a software application for presenting user interfaces to allow interaction with query server virtual environment platform 150. Presentation of a user interface may comprise any degree or type of rendering, depending on the type of user interface code. For example, a user device may execute a Web browser to receive a Web page (e.g., in HTML format) from the virtual environment platform 150 and/or may render and present the Web page according to known protocols. A user device may also or alternatively present user interfaces by executing a standalone executable file (e.g., an .exe file) or code (e.g., a JAVA applet) within a virtual machine.

Note that FIG. 1 represents a logical architecture for the system 100 according to some embodiments, and actual implementations may include more or different components arranged in other manners. Moreover, each system described herein may be implemented by any number of devices in communication via any number of other public and/or private networks. Two or more of devices may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

Any of the devices illustrated in FIG. 1, including the business service provider backend 110 and the virtual environment platform 150, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

All systems and processes discussed herein may be embodied in program code stored on one or more computer-readable media. Such media may include, for example, a floppy disk, a CD-ROM, a DVD-ROM, magnetic tape, OR solid state Random Access Memory (RAM) or Read Only Memory (ROM) storage units. Embodiments are therefore not limited to any specific combination of hardware and software.

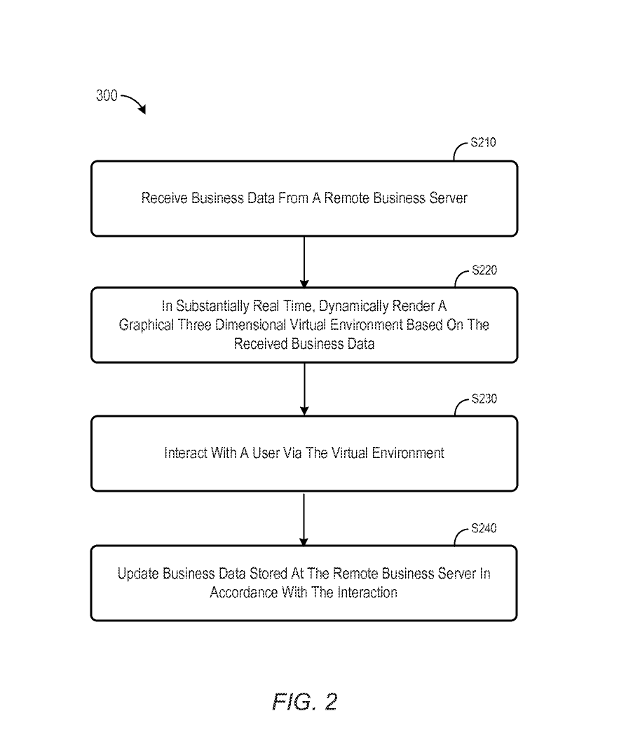

FIG. 2 is a flow diagram of a process 200 that might be associated with the system 100 of FIG. 1 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S210, business data may be received from a remote business server. For example, a virtual environment platform might receive inventory information, price data, product options, etc. from a remote business service provider backend 110 (e.g., via queries or any other protocol).

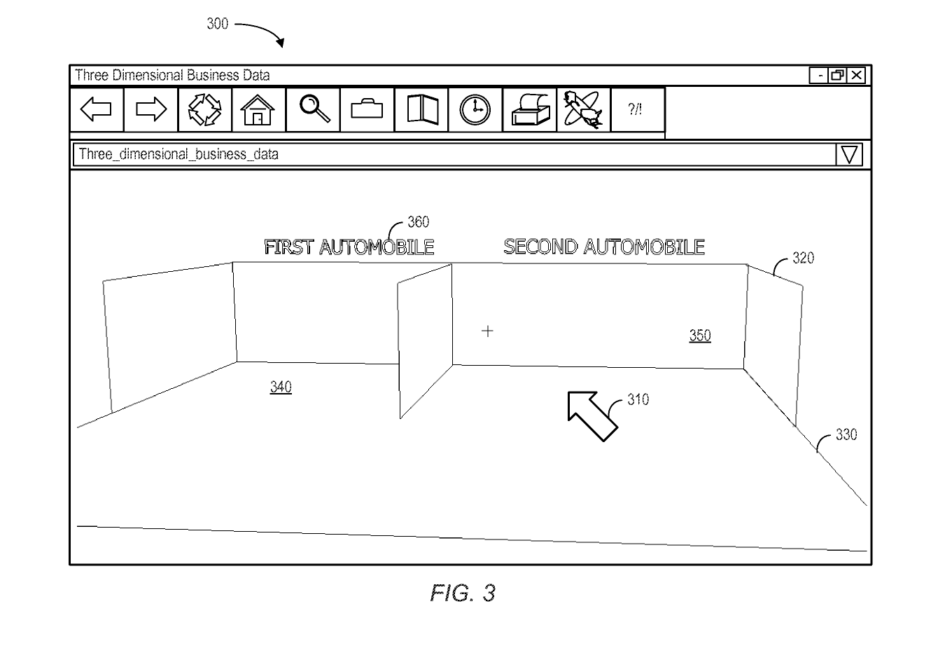

At S220, a graphical three-dimensional virtual environment may be dynamically rendered (e.g., in substantially real time) based on the received business data. For example, the virtual environment platform might receive business data indicating that two different automobiles are available from a particular enterprise that sells automobiles. In this case, FIG. 3 illustrates an example display 300 of a three-dimensional virtual environment that might be provided to a user based on that business data in accordance with some embodiments. In particular, the display 300 includes graphics representing three dimensional virtual walls 320 and a virtual floor 330 so as to define two distinct areas 340, 350 (e.g., “rooms”) along with text 360 indicating that the first area 340 is associated with a “first automobile” and the second area 350 is associated with a “second automobile.” Note that the different areas might be associated with different merchants, different products, different services, and/or different stages of a transaction.

Referring again to FIG. 2, at S230 the virtual environment platform may interact may with a user via the virtual environment. For example, a user might interact with the virtual environment via a keyboard, touchscreen, mouse, etc. In the display of FIG. 3, for example, a user might interact with the virtual environment via a cursor 310 to navigate (e.g., “walk”) to the first area 340 or the second area 350 (e.g., to indicate he or she is interested in learning more about the first or second automobile) and/or to select objects that might be present in the virtual environment. Note that the display 300 might be rendered from the user's “point of view” or might include an avatar representing the user (e.g., he or she might see themselves walk around within the display 300).

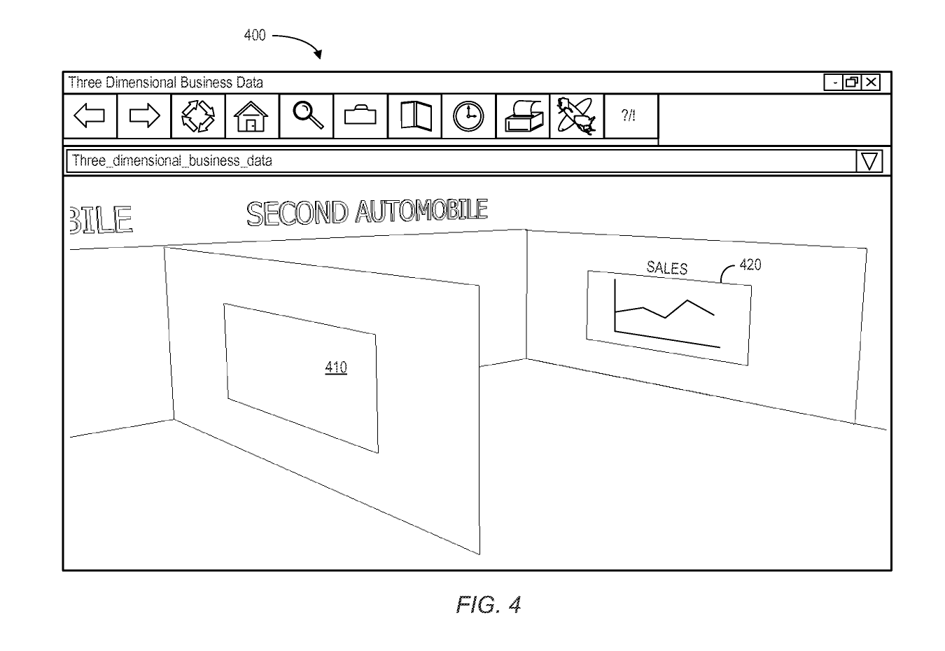

According to some embodiments, the interaction between the user and the virtual environment includes providing supplemental business information to the user. For example, FIG. 4 illustrates a display 400 of supplemental business information in accordance with some embodiments. In particular, the display 400 includes a first virtual display pane 410 (e.g., associated with the first automobile) and a second virtual display pane 420 (e.g., associated with the second automobile). The display panes 410, 420 could provide, for example, charts, text, pictures, videos, etc. In the example of FIG. 4, the second display pane 420 is showing a sales figure chart associated with the second automobile. According to some embodiments, the user may interact with the display panes 410, 420 (e.g., by filling out a form displayed in a pane) and/or the information in the in the display panes 410, 420 may change (e.g., as the user moves closer to the second display pane 420, the chart may be replaced with a spreadsheet showing the exact sales numbers associated with the second automobile). Note that the “supplemental information” provided to the user might include any type of enterprise data, including profit data, order data, human resources data, contact data, message data, etc. In some embodiments, the interaction includes receiving input from the user, such as a display selection, message data (e.g., a message to a seller), a business action, voice input, touchscreen gestures, hand movement, and/or eye tracking input. Note that the interactions might be associated with filling-in a form, negotiations, and/or signing a contract.

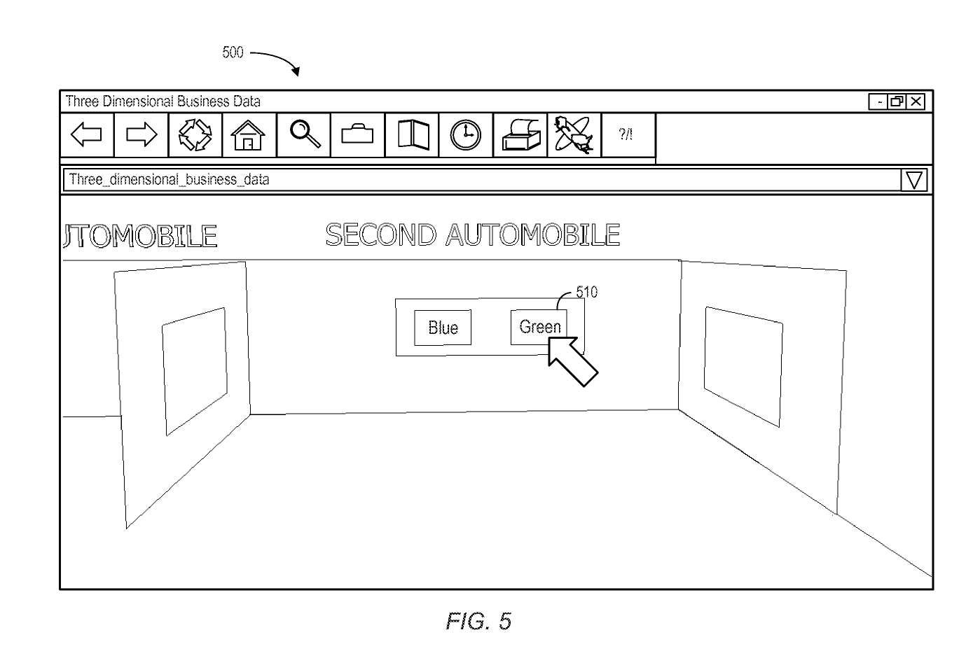

According to some embodiments, the interacting is associated with a transaction between the user and a merchant associated with the remote business server. For example, the interacting may include navigation to and selection of an item in the virtual environment by the user (e.g., associated with selection of a product feature in the real world). Consider, for example, FIG. 5 which illustrates a display 500 including a selectable item 510 in accordance with some embodiments. In particular, the selection of the selectable item 510 indicates that the user is interested in a “Green” product feature for the second automobile (e.g., as opposed to a “Blue” product feature).

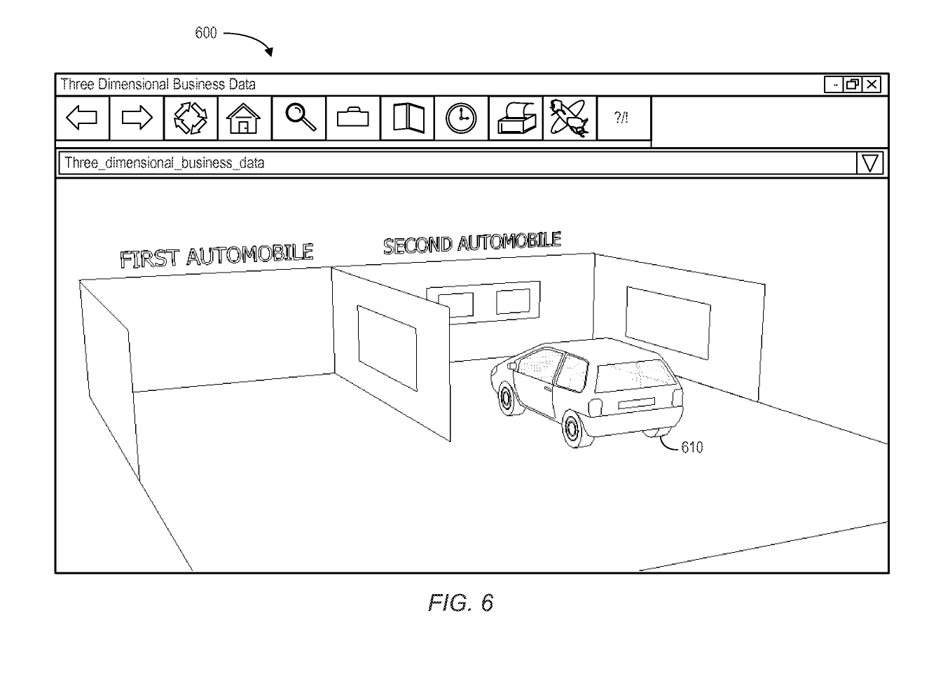

According to some embodiments, a virtual environment platform may receive product information from the remote business server. Moreover, the virtual environment platform may, in substantially real time, dynamically render a graphical three-dimensional representation of the product within the virtual environment based on the received product data. For example, FIG. 6 illustrates a display 600 of a three-dimensional representation of the second automobile 610 in accordance with some embodiments. The user may then walk around the automobile 610 and/or pickup and rotate the automobile 610 to view it from different angles. Note that the automobile might be rendered as being “Green” based on the user's selection as described with respect to FIG. 5.

Referring again to FIG. 2, at S240 business data stored at the remote business server may be automatically updated in accordance with the user interaction. For example, the user's contact information (e.g., email address and telephone number) and an offer price might be transmitted from the virtual environment platform to the remote business server to update the stored business data.

According to some embodiments, the virtual environment and/or user interactions include meeting with rendered representation of a plurality of other people within the virtual environment. For example, the virtual environment might include avatars or other figures representing a salesperson, a banker, the user's friend or spouse, etc. Note that different people within the virtual environment might view different items and/or have access to different sets of information (e.g., the banker might see a price associated with an automobile while the user's friends cannot see the price). According to some embodiments, one person might invite another person to a meeting, a private chat (e.g., including text, audio, and/or video chats). In this way, the user might be able to discuss options with a salesperson, negotiate a loan with a banker, and receive opinions from his or her friends—all within the virtual environment.

According to some embodiments, a virtual environment platform may include or interact with a business gateway that exchanges information with a plugin (e.g., via a gateway handler). The gateway might, for example, handle interactions with an ABAP business system that exposes data that can be consumed by a standard Application Programming Interface (“API”). The plugin might, for example, execute at an audio/visual software application, a dedicated device, and/or extension infrastructure.

Thus, embodiments may provide access to business data in a relatively engaging manner for a user. Note that embodiments might not bind to web and might be implemented on an objective C application. Moreover, a three dimensional object may be defined to a let the user view videos and pictures, edit documents, etc. Further note that such objects might be viewed differently at different times (e.g., from different distances and/or angles). According to some embodiments, a three dimensional object can create another three dimensional object (e.g., an object in a room) and/or communicate with other objects.

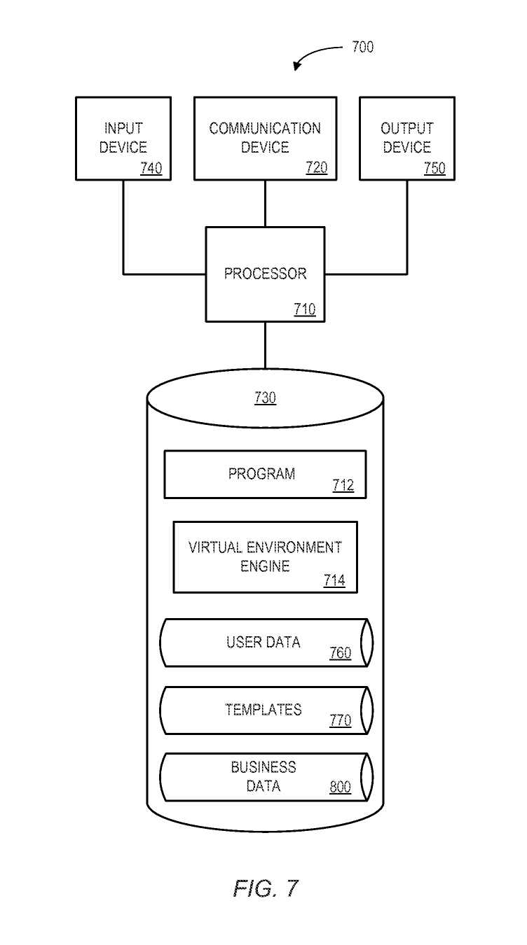

Note that the architecture described with respect to FIG. 1 is provided only as an example, and any other type of apparatus might be provided instead. For example FIG. 7 is a block diagram overview of one such apparatus 700 according to some embodiments. The apparatus 700 may be, for example, associated with a virtual environment platform and/or user device. The apparatus 700 comprises a processor 710, such as one or more commercially available Central Processing Units (CPUs) in the form of one-chip microprocessors, coupled to a communication device 720 configured to communicate via a communication network (not shown in FIG. 7). The communication device 720 may be used, for example, as an input path to receive business system data. The apparatus 700 further includes an input device 740 (e.g., a mouse and/or keyboard to enter design information associated with a virtual environment) and an output device 750 (e.g., a computer monitor to display administrative information).

The processor 710 communicates with a storage device 730. The storage device 730 may comprise any appropriate information storage device, including combinations of magnetic storage devices (e.g., a hard disk drive), optical storage devices, and/or semiconductor memory devices. The storage device 730 stores a program 712 and/or virtual environment engine 714 for controlling the processor 710. The processor 710 performs instructions of the programs 712, 714, and thereby operates in accordance with any of the embodiments described herein. For example, the processor 710 might receive business data from a remote business server. A graphical three-dimensional virtual environment may then be dynamically rendered, in substantially real time, by the processor 710 based on the received business data. The processor 710 may facilitate interaction between a user via the virtual environment, and business data stored at the remote business server may be updated by the processor 710 in accordance with the interactions.

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the apparatus 700 from another device; or (ii) a software application or module within the apparatus 700 from another software application, module, or any other source.

In some embodiments (such as shown in FIG. 7), the storage device 730 stores user data 760, templates 770 (e.g., of potential virtual environments that may be selectable by a designer), and business data 800 (e.g., received from a remote business system). An example of business data 800 that may be used in connection with the apparatus 700 will now be described in detail with respect to

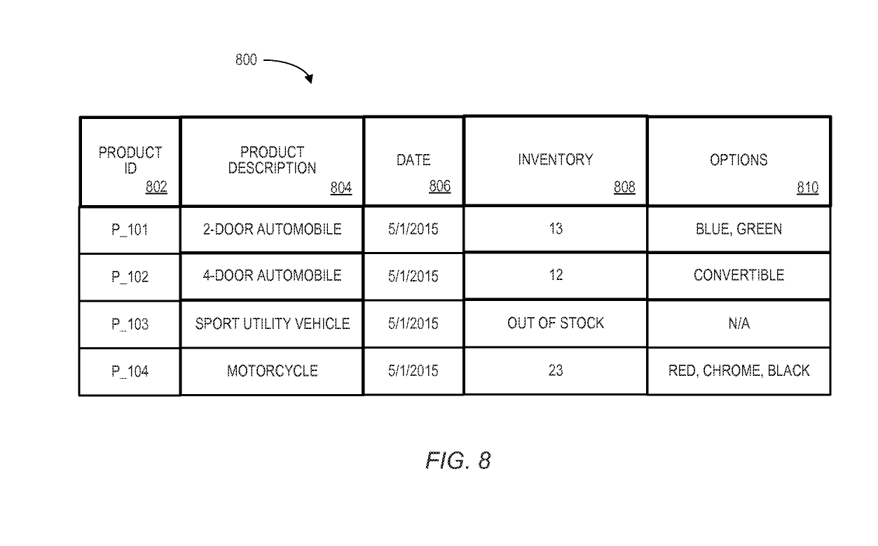

FIG. 8. Note that the database described herein is only an example, and additional and/or different information may be stored therein. Moreover, various databases might be split or combined in accordance with any of the embodiments described herein.

Referring to FIG. 8, a table is shown that represents the business data 800 that may be stored at the apparatus 700 according to some embodiments. The table may include, for example, entries identifying products available from a retailer associated with a remote business system. The table may also define fields 802, 804, 806, 808, 810 for each of the entries. The fields 802, 804, 806, 808, 810 may, according to some embodiments, specify: a product identifier 802, a product description 804, a date 806, inventory information 808, and options 810. The information in the business data 800 may be created and updated, for example, based on data received from a remote business system and/or a user interacting with a virtual environment.

The product identifier 802 may be, for example, a unique alphanumeric code identifying an automobile that may be available from a seller and the product description 804 may describe the automobile. The date 806 and inventory 808 may reflect the real-time number of automobiles that are currently available at the seller's real-world showroom. This information may then be used to render an accurate three dimensional virtual world for a user (e.g., the Sport

Utility Vehicle would not be rendered because the inventory 808 indicated it is currently “out of stock”). The options 810 might represent automobile options that are available from the seller and/or that have been selected by the user (buyer) within the three dimensional virtual world.

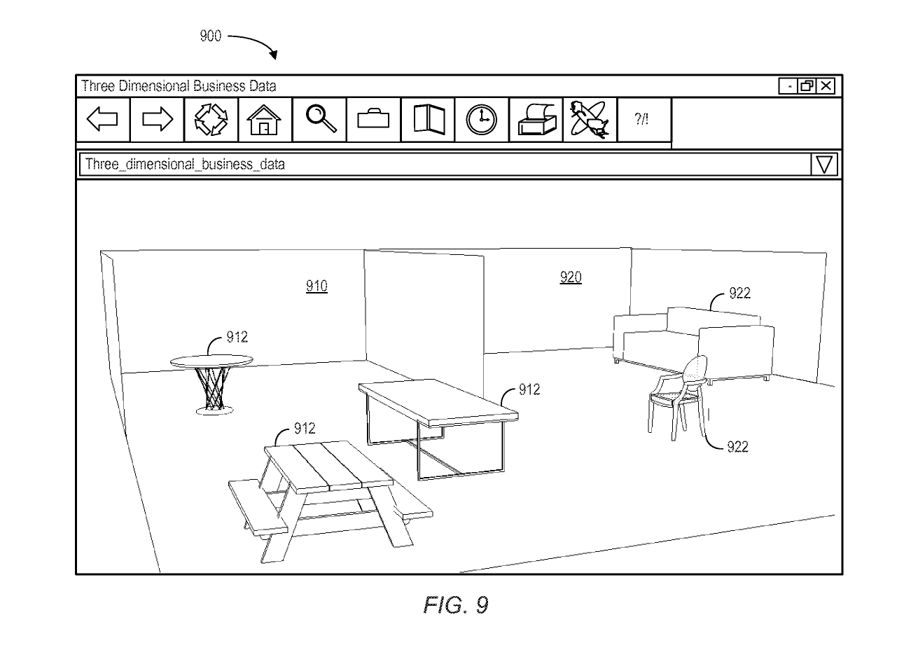

Although automobiles have been used herein as an example, note that embodiments may be associated with any type or product, service, or business data. For example, FIG. 9 illustrates a display 900 of a three-dimensional virtual environment in accordance with another embodiment. In this example, a first area 910 displays a number of different tables 912 while a second area 920 displays a number of different chairs 922. Other embodiments might be associated with, for example, a bookstore or supermarket (and the virtual world might be arranged in a manner similar to the real world stores such that a customer can easily and intuitively navigate directly to the section and/or item he or she is interested in).

Thus, some embodiments may establish methods and mechanisms to efficiently, accurately, and automatically provide business data via a three dimensional virtual environment. Moreover, embodiments may let a business user get real time contextual data from their business systems via a virtual environment. According to some embodiments, an alert may be displayed in the virtual environment whenever relevant business context is detected. Moreover, related information from the user's business systems may be provided based on where he or she is virtually “located” at any given time. Still further, embodiments may let a viewer perform business actions using a three dimensional virtual environment as the user interface.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to business systems, note that embodiments may be associated with other types of enterprise data. For example, financial, governmental, and/or medical information may be processed in accordance with any of the embodiments described herein.

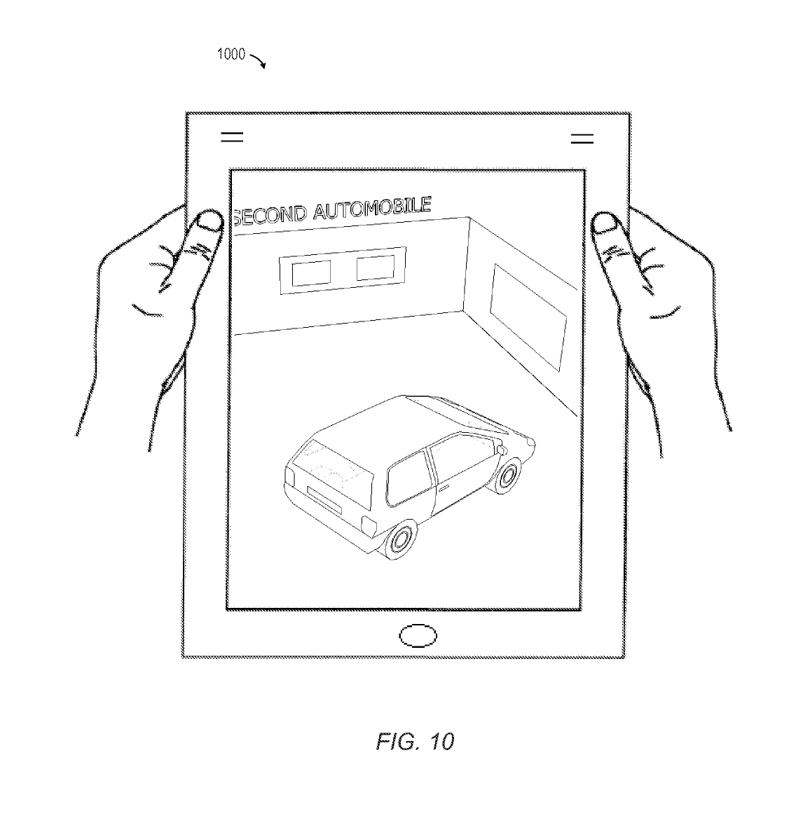

Moreover, while embodiments have been illustrated using particular display devices, embodiments may be implemented in any other of a number of different ways. For example, some embodiments might be associated with tablet computers, smartphone, etc. FIG. 10 illustrates a display of a three-dimensional virtual environment on a tablet and/or wireless device 1000 in accordance with some embodiments.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer implemented method, comprising:
receiving business data from a remote business server;
in substantially real time, dynamically rendering a graphical three-dimensional virtual environment based on the received business data;
interacting with a user via the virtual environment; and
automatically updating business data stored at the remote business server in accordance with said interaction.

2. The method of claim 1, wherein said interacting is associated with a transaction between the user and a merchant associated with the remote business server.

3. The method of claim 2, wherein the virtual environment includes a plurality of defined areas, wherein different areas are associated with at least one of: (i) different merchants, (ii) different products, (iii) different services, and (iv) different stages of a transaction.

4. The method of claim 2, wherein said interacting includes navigation to and selection of an item in the virtual environment by the user, said selection being associated with selection of a product feature in the real world.

5. The method of claim 1, further comprising:
receiving product information from the remote business server; and
in substantially real time, dynamically rendering a graphical three-dimensional representation of the product within the virtual environment based on the received product data

6. The method of claim 1, wherein said interacting is associated with at least one of: (i) filling-in a form, (ii) negotiations, and (iii) signing a contract.

7. The method of claim 1, wherein said interacting includes meeting with rendered representation of a plurality of other people within the virtual environment, wherein different people can view different items within the virtual environment.

8. The method of claim 1, wherein said interacting includes providing supplemental business information to the user.

9. The method of claim 8, wherein the supplemental business information is associated with at least one of: (i) enterprise data, (ii) sales data, (iii) profit data, (iv) order data, (v) human resources data, (vi) contact data, and (vii) message data.

10. The method of claim 1, wherein said interacting comprises receiving input from the user.

11. The method of claim 10, wherein the received input is associated with at least one of: (i) a display selection, (ii) message data, (iii) a business action, (iv) voice input, (v) touchscreen gestures, (vi) hand movement, and (vii) eye tracking input.

12. The method of claim 1, wherein the remote business server is associated with at least one of: (i) an enterprise resource planning server, (ii) a business services gateway, (iii) a hypertext transfer protocol server, (iv) an Advanced Business Application Programming server, (v) a cloud-based business application, and (vi) a TCP/IP server.

13. A non-transitory, computer-readable medium storing program code executable by a computer to:
receive business data from a remote business server;
in substantially real time, dynamically render a graphical three-dimensional virtual environment based on the received business data;
interact with a user via the virtual environment; and
update business data stored at the remote business server in accordance with said interaction.

14. The medium of claim 13, wherein said interaction is associated with a transaction between the user and a merchant associated with the remote business server.

15. The medium of claim 14, wherein the virtual environment includes a plurality of defined areas, wherein different areas are associated with different merchants.

16. The medium of claim 14, wherein said interaction includes navigation to and selection of an item in the virtual environment by the user, said selection being associated with selection of a product feature in the real world.

17. The medium of claim 13, further storing program code executable by a computer to:
receive product information from the remote business server; and
in substantially real time, dynamically render a graphical three-dimensional representation of the product within the virtual environment based on the received product data

18. The medium of claim 13, wherein said interacting is associated with at least one of: (i) filling-in a form, (ii) negotiations, and (iii) signing a contract.

19. The medium of claim 13, wherein said interacting includes meeting with rendered representation of a plurality of other people within the virtual environment, wherein different people can view different items within the virtual environment.

20. A system, comprising:
an input path to receive business data from a remote business server;
a virtual environment platform coupled to the input path, to:
in substantially real time, dynamically render a graphical three-dimensional virtual environment based on the received business data,
interact with a user via the virtual environment, and
update business data stored at the remote business server in accordance with said interaction.

21. The system of claim 20, wherein said interaction is associated with a transaction between the user and a merchant associated with the remote business server.

22. The system of claim 21, wherein the virtual environment includes a plurality of defined areas, wherein different areas are associated with different merchants.
